(19) United States
(12) Patent Application Publication
(10) Pub. No.: US 2011/0289272 A1
(43) Pub. Date: Nov. 24, 2011

(54) Apparatus and methods for restoring data in a RAID system

(75) Inventors: Sen-Lan Chu, Hsinchu County (TW); Zong-Yi Fang, Hsinchu County (TW); Chao-Liang Chan, Hsinchu County (TW)

(73) Assignee: ACCUSYS, INC., Hsinchu County (TW)

(21) Appl. No.: 12/927,973

(22) Filed: Nov. 29, 2010

(30) Foreign Application Priority Data
May 24, 2010 (TW) 099116565

(51) Int. Cl. G06F 12/00

(52) U.S. Cl. 711/114; 711/E12.001

(57) ABSTRACT

The present invention provides a RAID controller and an operation method thereof, to avoid buffer data loss due to accidental power loss for a long period of time. The RAID controller comprises a first memory, a switch and a functional module. The first memory stores a buffer data. The switch is coupled to the first memory. The functional module is coupled to the switch, and has a second memory. The functional module causes the switch to be connected to the first memory based on a pre—determined instruction, to backup the buffer data by means of the second memory.

The present invention relates to a redundant array of inexpensive disks (or redundant array of independent disks, RAID) control device, particularly an apparatus and operating method of a RAID control device which is able to avoid buffer data loss due to accidental power loss for a long period of time.

### BACKGROUND OF THE INVENTION

To prevent the data stored in servers or computer systems from loss by accident, it is a popular method of using RAID controllers for the backup and management of the data stored in the hard disks. Please refer to FIG. 1, which illustrates a typical structure of the RAID control system. Generally speaking, the performance in terms of data storage efficiency of the volatile memories, such as DRAM, DDR2 and SDRAM, is much higher than that of the ordinary non-volatile memories, such as Flash memory, ROM and EPROM for example. Therefore, the RAID control system takes advantage of a volatile memory 110 shown in FIG. 1 for temporary data buffering, so as to accommodate the data transmission rate between the RAID device and the main computer or server.

Since the volatile memory 110 can maintain the data buffered therein only when under a continual power-supplying condition, designers of the RAID system usually adopt the idea of attaching a battery back-up unit 120 at the volatile memory 110 to prevent the data from getting lost due to accidental power loss for a long period of time.

Referring to FIG. 1, a RAID control unit 130 receives data, which is transmitted from a server or a computer (not shown) to hard disk devices for data storage, via a machine interface 150. The data is temporarily stored (or buffered) in the volatile memory 110. Then, the RAID control unit 130 either stores or backups the buffer data into the hard disk devices (not shown) via a hard disk interface 140.

For years the actual application of the battery back-up unit 120 in the RAID control system is usually a lithium battery, which is being charged when the system is on. When an accidental power-off occurs, the lithium battery may maintain the necessary power supply to the volatile memory 110 until the next power-on of the system. And, the buffer data in the volatile memory 110 will then be written into the hard disk devices. However, there exits several drawbacks for the application of lithium batteries in RAID systems. Firstly, the battery lifetime is a main issue. The capability of power storage of lithium batteries declines by half (or, 50%) in every 1-2 years, so the status of power storage of the batteries need to be continually monitored and the battery devices need to be timely replaced with new ones. Besides, the time period for using a lithium battery to maintain the data kept in a volatile memory is limited, usually being a maximum of 72 hours. If the RAID system is not powered on by the end of such a time period, the data stored in the volatile memory will be lost.

To overcome the abovementioned drawback, the present invention provides a RAID controller and an operation method thereof. The main idea of the present invention is to backup the buffer data from the volatile memory to a non-volatile memory with the electrical power stored in at least a capacitor within a short period of time, after an accidental power-off occurs, and then restore the data into the volatile memory when the system is rebooted. Thus, the RAID control device according to the present invention may sufficiently replace the traditional systems using the battery back-up unit, does not need to monitor the status of the power source, and outperforms the current RAID control devices in terms of safer data storage.

### SUMMARY OF THE INVENTION

The present invention provides a RAID controller and an operation method thereof, to avoid buffer data loss due to accidental power loss for a long period of time. The RAID controller comprises a first memory, a switch and a functional module. The first memory stores a buffer data. The switch is coupled to the first memory. The functional module is coupled to the switch, and has a second memory. The functional module causes the switch to be connected to the first memory based on a pre-determined instruction, to backup the buffer data by means of the second memory.

Preferably, the RAID controller further comprises a control unit, which is coupled to the switch, storing the buffer data into the first memory under a condition of a normal power supply, and continuously transmitting a hold instruction to the functional module, to allow the functional module to put the pre-determined instruction on hold.

Preferably, the RAID controller further comprises at least a capacitor coupled to the first memory, the switch and the functional module, and providing an electric power to the first memory, the switch and the functional module when the normal power supply is off.

Preferably, the first memory is a volatile memory and the second memory is a non-volatile memory.

Preferably, the switch is a Y-type switch.

In accordance with another aspect of the present invention, a RAID controller is provided. The RAID controller comprises a first memory storing a buffer data, a second memory and a control device. The first memory stores a buffer data. The control device starts to establish a connection between the first and the second memories in response to a pre-determined instruction, and causes the second memory to store the buffer data.

Preferably, the RAID controller further comprises a control unit, which is coupled to the control device, storing the buffer data into the first memory under a condition of a normal power supply, and continuously transmitting a hold instruction to the control device, to allow the control device to put the pre-determined instruction on hold.

In accordance with another aspect of the present invention, a method for avoiding data loss in a RAID controller having a first and a second memories, the method comprises the steps of providing a pre-determined instruction and putting the pre-determined instruction on hold under a condition of a normal power supply. The pre-determined instruction includes operations of connecting the first memory to the second memory and backing up a buffer data stored in the first memory into the second memory.

Preferably, the method further comprises a step of putting a boot process on hold until the buffer data stored in the first memory has been backed up into the second memory, after an accidental interruption to the normal power supply.

Preferably, the first memory is a volatile memory and the second memory is a non-volatile memory.

In accordance with a further aspect of the present invention, a method for avoiding data loss in a RAID controller having a first and a second memories is provided. The method comprises the steps of providing a pre-determined instruction under a condition of a normal power supply and executing the pre-determined instruction under a condition of an accidental power shut-off. The pre-determined instruction includes operations of connecting the first memory to the second memory and backing up the buffer data stored in the first memory into the second memory.

Preferably, the method further comprises the steps of using an identification code to indicate whether a last shutdown of the RAID controller is under the condition of the normal power supply, setting the identification code at a first identification status when the last shutdown of the RAID controller is shutdown under the condition of the normal power supply, and storing the data backed up in the second memory into the first memory if the identification code is not set at the first identification status.

In accordance with a further aspect of the present invention, a method for avoiding data loss in a RAID controller is provided. The method comprises the steps of providing a pre-determined instruction; and continually transmitting a control instruction to put the pre-determined instruction on hold under a condition of a normal power supply.

Preferably, the step of providing the pre-determined instruction comprises sub-steps of connecting the first memory to the second memory and backing up a buffer data stored in the first memory into the second memory.

The above objects and advantages of the present invention will be more readily apparent to those ordinarily skilled in the art after reading the details set forth in the descriptions and drawings that follow, in which:

### BRIEF DESCRIPTION OF THE DRAWINGS

FIG. 1 is a schematic diagram showing a typical structure of the RAID control system known to the art;

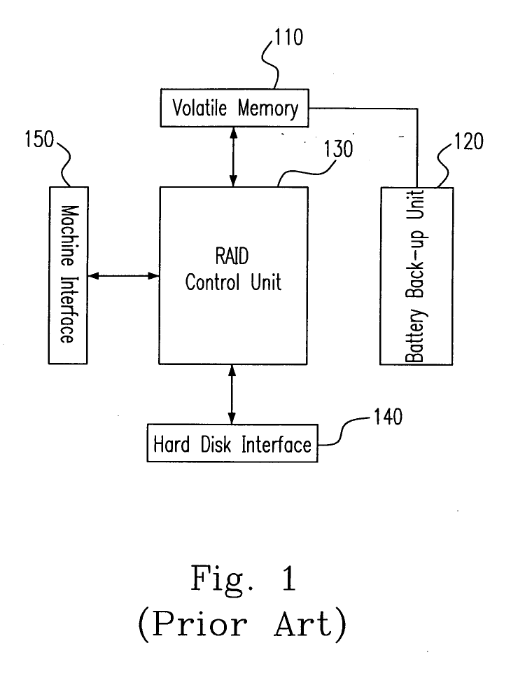

FIG. 2 is a schematic diagram illustrating the functional blocks of the RAID control device according to an embodiment of the present invention;

FIG. 3 illustrates the method of avoiding data loss in a RAID control device according to one embodiment of the present invention;

FIG. 4 illustrates the boot and data restore process of the method of avoiding data loss in a RAID control device according to one embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

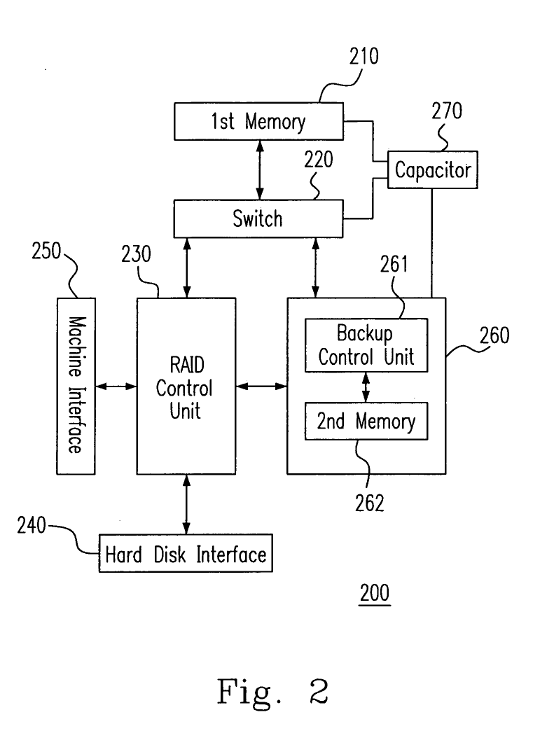

Please refer to FIG. 2, a schematic diagram illustrating the functional blocks of the RAID control device in accordance with an embodiment of the present invention. According to FIG. 2, a RAID control 200 includes a first memory 210, a switch 220, a RAID control unit 230, a hard disk interface 240, a machine interface 250, a backup module 260 and at least a capacitor 270. The backup unit 260 comprises a backup control unit 261 and a second memory 262. In a preferred embodiment, the switch 220 is a Y-type port switch, the first memory 210 is a volatile memory, and the second memory 262 is a non-volatile memory. The at least one capacitor 270 is coupled to the first memory 210, the switch 220 and the backup module 260, remains being charged when the system has been booted and under a condition of normal power supply, to provide necessary electrical power to the first memory 210, the switch 220 and the backup module 260 after an accidental interruption to the normal power supply such as power loss. The amount of electricity provided by the at least one capacitor 270 is based on the need of those components that relies on the electricity to complete their functions after the accidental interruption to the normal power supply has occurred.

Again, referring to FIG. 2, the switch 220 is coupled to the first memory 210 at one end, and coupled to the RAID control unit 230 and the backup module 260 at the other ends respectively. Under a condition of normal power supply, which is usually after the system is powered on, the switch 220 maintains an electrical connection with the RAID control unit 230 while there is no connection, or an open circuit, between the switch 220 and the backup module 260. The RAID control unit 230 receives data to be stored in a hard disk device (not shown) from a server or a computer (not shown) via the machine interface 250. The data is buffered in the first memory 210. The RAID control unit 230 will then either store or backup the buffer data into the hard disk device (not shown) via the hard disk interface 240.

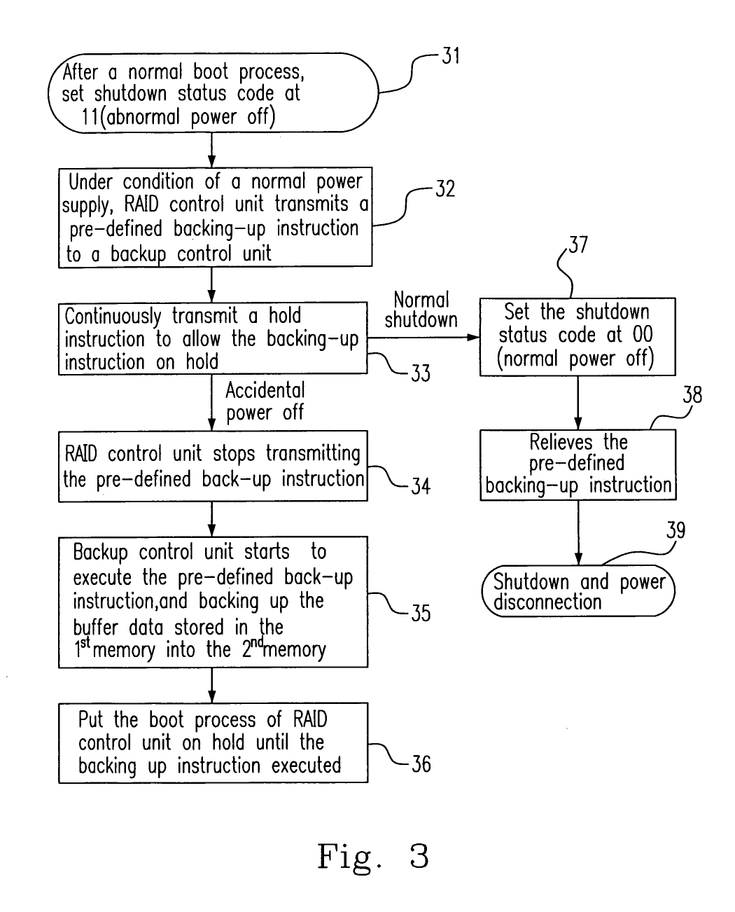

Please refer to FIG. 3, which illustrates the method of avoiding data loss in a RAID control device in accordance with one embodiment of the present invention. First of all, for the need of determining whether the last shutdown or power off of the RAID control device 200 was under a condition of an accidental interruption to the normal power supply such as power loss, the present invention make use of a shutdown status code. After a normal boot process, the RAID control unit 230 set the shutdown status code at a first identification status, says 11 for example, indicating abnormal power-off (Step 31). Accordingly, the shutdown status code in the RAID control unit 230 will remain at a first identification status, says 11 for example, if an accidental power loss occurs to the RAID control device 200.

Under a condition of a normal power supply, the RAID control unit 230 transmits a pre-defined backing-up instruction to the backup control unit 261 (Step 32). The backing-up instruction provides operation instructions to the backup module 260 regarding the emergency data backup after an abnormal power-off. Certainly, there is no need to execute the backing-up instruction under the condition of normal power supply. Thus, having completing the Step 32, the RAID control unit 230 must continually transmit a hold instruction to instruct the backup control unit 261 to put off the backing-up instruction, to allow the backing-up instruction on hold (Step 33).

After an accidental power-off occurs, the devices of the RAID control unit 230 stop functioning due to the electricity that the devices rely on is off, and therefore the RAID control unit 230 stops transmitting the pre-defined back-up instruction (Step 34). Referring to FIG. 2, after the accidental power-off, the electricity stored in the capacitor 270 can maintain the operations of the first memory 210, the switch 220 and the backup module 260 temporarily. When the backup control unit 261 has not received the hold instruction for a certain period of time, it will start to execute the pre-defined back-up instruction.

Once again, referring to the structure illustrated in FIG. 2, the first memory 210 is coupled to the RAID control unit 230 via the switch 220 under a condition of normal power supply, while the connection between the first memory 210 and the second memory 262 is open, which is controlled by the switch 220. The pre-defined instruction firstly requests the switch 220 to establish the connection between the first and the second memories 210, 262. In one preferred embodiment, the abovementioned instruction can be completed by simply switch the contact between the switch 220 and the RAID control unit 230 toward the new contact between the switch 220 and the backup module 260, to allow the backup module 260 to execute the backup process afterwards. When the connection between the first and the second memories 210, 262 is established, the backup control unit 261_starts to backup the buffer data stored in the first memory 210 into the second memory 262 (Step 35).

To assure the backup process has been completed, the normal boot process of the RAID control unit has to be put on hold until the backing-up instruction has been executed and all the backup data has been backed up into the second memory 262 (Step 36). When the RAID control unit 230 is turned on and the shutdown status code is at 11, the normal boot process is prohibited or held. When all the data has been backed up into the second memory 262, the backup control unit 261 shows an identifier indicating the completion of the backup process, or submits a signal to indicate the completion of the backup process, to help the RAID control unit 230 recognize the backup status.

On the other hand, when the system is shutdown under a normal condition, the RAID control unit 230 set the shutdown status code at a second identification status, says 00 for example, indicating a normal power-off (Step 37), relieves the pre-defined backing-up instruction (Step 38), and then shutdown the system and disconnect the power (Step 39).

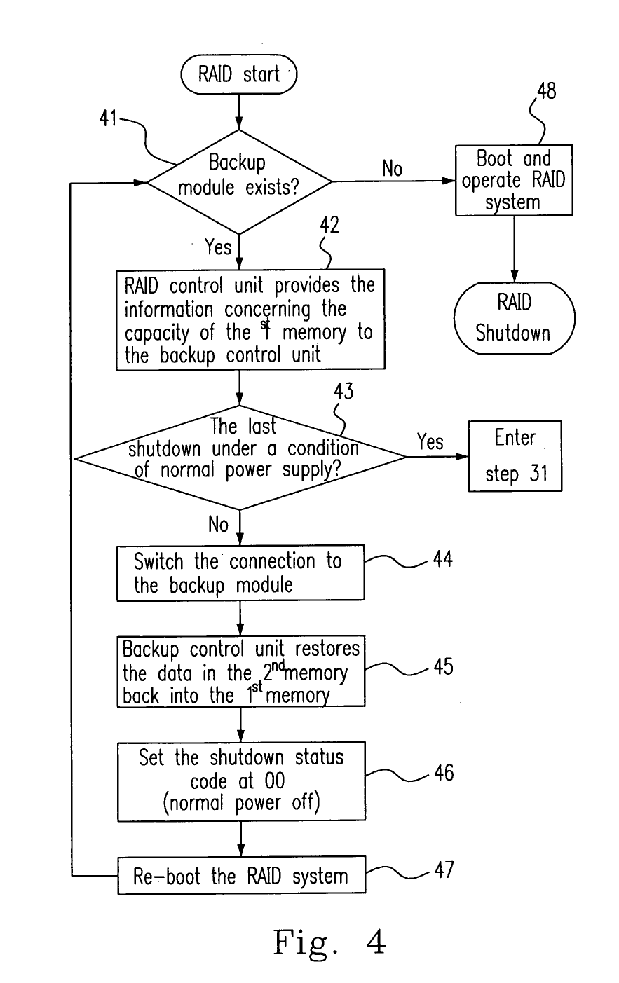

Please refer to FIG. 4, which illustrates the boot and data restore process of the method of avoiding data loss in a RAID control device in accordance with one embodiment of the present invention. In one specific embodiment, if the system is started and the RAID control device has a backup module, such as the backup module 260 illustrated in FIG. 2 (Step 41), the RAID control unit 230 has to provide the information concerning the memory capability of the first memory 210 to the backup control unit 261 (Step 42), for the preparation of potential need of backup or restoring based on the information.

The RAID control unit 230 may refer to the status of the shutdown identification code to determine whether the last shutdown is under a condition of normal power supply or not (Step 43). It is to be noted that the mentioned embodiments use binary code for instance, the actual practice shall not be limited to binary codes.

If the status of the shutdown identification code indicates the last power off of the RAID control unit 230 is not at a condition of normal power supply, in other words, the last power-off of the device is due to accidental power-off, the data in the first memory 210 should have been backed up into the second memory 262 according to the process set for above. At this moment, the RAID control unit 230 instructs the switch 220 to establish a connection between the first memory 210 and the backup module 260 (Step 44), and have the backup control unit 261 to restore the backup data from the second memory 262 into the first memory 210 (Step 45). Then, the RAID control unit 230 set the shutdown status identification code to 00, to indicate the condition of normal power-off (Step 46), and reboot the RAID system (Step 47). Later, the process flow comes through Steps 41, 42 and 43, the RAID control unit 230 will choose to enter the step 31 in FIG. 3 since the shutdown status identification code is 00.

Based on the above, the present invention provides an apparatus as well as a method to avoid the buffer data in the first memory 210 getting lost due to accidental power-off for a long period of time. In addition, the method provided by the present invention does not need to monitor the condition of the power supply of the system while allowing the backup module 260 timely implement the data backup. For the aspect of hardware structure, with or without the backup module 260, the normal operations of the RAID control device will not be interrupted.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims that are to be accorded with the broadest interpretation so as to encompass all such modifications and similar structures.

What is claimed is:

1. A redundant array of independent disks (RAID) controller, comprising:
a first memory storing a buffer data;
a switch coupled to the first memory; and
a functional module coupled to the switch, and having a second memory, wherein the functional module causes the switch to be connected to the first memory based on a pre-determined instruction, to backup the buffer data by means of the second memory.

2. A RAID controller as claimed in claim 1, further comprising:
a control unit coupled to the switch, storing the buffer data into the first memory under a condition of a normal power supply, and continuously transmitting a hold instruction to the functional module, to allow the functional module to put the pre-determined instruction on hold.

3. A RAID controller as claimed in claim 2, further comprising:
at least a capacitor coupled to the first memory, the switch and the functional module, and providing an electric power to the first memory, the switch and the functional module when the normal power supply is off.

4. A RAID controller as claimed in claim 1, wherein the first memory is a volatile memory and the second memory is a non-volatile memory.

5. A RAID controller as claimed in claim 4, further comprising:
a control unit coupled to the switch, storing the buffer data into the first memory under a condition of a normal power supply, and continuously transmitting a hold instruction to the functional module, to allow the functional module to put the pre-determined instruction on hold.

6. A RAID controller as claimed in claim 4, wherein the switch is a Y-type switch.

7. A RAID controller as claimed in claim 6, further comprising:
a control unit coupled to the switch, storing the buffer data into the first memory under a condition of a normal power supply, and continuously transmitting a hold instruction to the functional module, to allow the functional module to put the pre-determined instruction on hold.

8. A redundant array of independent disks (RAID) controller, comprising:
a first memory storing a buffer data;
a second memory; and
a control device starting to establish a connection between the first and the second memories in response to a pre-determined instruction, and causing the second memory to store the buffer data.

9. A RAID controller as claimed in claim 8, wherein the first memory is a volatile memory and the second memory is a non-volatile memory.

10. A RAID controller as claimed in claim 8, further comprising:
a control unit coupled to the control device, storing the buffer data into the first memory under a condition of a normal power supply, and continuously transmitting a hold instruction to the control device, to allow the control device to put the pre-determined instruction on hold.

11. A method for avoiding data loss in a redundant array of independent disks (RAID) controller having a first and a second memories, the method comprising the steps of:
providing a pre-determined instruction, wherein the pre-determined instruction includes operations of:
connecting the first memory to the second memory; and
backing up a buffer data stored in the first memory into the second memory; and
putting the pre-determined instruction on hold under a condition of a normal power supply.

12. A method as claimed in claim 11, further comprising a step of:
after an accidental interruption to the normal power supply, putting a boot process on hold until the buffer data stored in the first memory has been backed up into the second memory.

13. A method as claimed in claim 11, wherein the first memory is a volatile memory and the second memory is a non-volatile memory.

14. A method for avoiding data loss in a redundant array of independent disks (RAID) controller having a first and a second memories, the method comprising the steps of:
under a condition of a normal power supply, providing a pre-determined instruction including operations of:
connecting the first memory to the second memory; and
backing up the buffer data stored in the first memory into the second memory; and
under a condition of an accidental power shut-off, executing the pre-determined instruction.

15. A method as claimed in claim 14, wherein the first memory is a volatile memory and the second memory is a non-volatile memory.

16. A method as claimed in claim 14, further comprising the steps of:
using an identification code to indicate whether a last shutdown of the RAID controller is under the condition of the normal power supply;
setting the identification code at a first identification status when the last shutdown of the RAID controller is shutdown under the condition of the normal power supply; and
storing the data backed up in the second memory into the first memory if the identification code is not set at the first identification status.

17. A method as claimed in claim 16, wherein the first memory is a volatile memory and the second memory is a non-volatile memory.

18. A method for avoiding data loss in a redundant array of independent disks (RAID) controller, the method comprising the steps of:
providing a pre-determined instruction; and
under a condition of a normal power supply, continually transmitting a control instruction to put the pre-determined instruction on hold.

19. A method as claimed in claim 18, wherein the RAID controller comprises a first memory being a volatile memory, and a second memory being a non-volatile memory.

20. A method as claimed in claim 19, wherein the step of providing the pre-determined instruction comprises sub-steps of:
connecting the first memory to the second memory; and
backing up a buffer data stored in the first memory into the second memory.
